(19) United States
(12) Patent Application Publication
(10) Pub. No.: US 2013/0275417 A1
(43) Pub. Date: Oct. 17, 2013

(54) SYSTEM AND METHOD FOR GENERATING ACTIVITY RECOMMENDATIONS

(71) Applicant: Joseph R. Fernandes, New York, NY (US)

(72) Inventor: Joseph R. Fernandes, New York, NY (US)

(21) Appl. No.: 13/444,515

(22) Filed: Apr. 11, 2012

(51) Int. Cl. G06F 17/30

(52) U.S. Cl. 707/723; 707/769; 707/E17.014

(57) ABSTRACT

System and method for generating one or more activity recommendations for a user are provided. The method comprises steps of receiving selection for a first set of user inputs, retrieving one or more activities from an activity database module based on the selection of the user inputs, scoring the activities based on at least one predetermined parameter and presenting one or more activity recommendations to the user based on the scoring. The method further comprises enabling the user to perform at least one activity from the one or more activity recommendations.

### BACKGROUND OF THE INVENTION

1. Field of the Invention

The invention generally relates to systems and methods of providing recommendations to a user, and more particularly to systems and methods of providing one or more activity recommendations relevant to fulfill a need of the user.

2. Description of the Prior Art

Users typically depend on Internet for posing queries in order to obtain recommendations. Conventionally, users utilize various search tools to resolve their queries corresponding to various fields. Such search tools include generic web search engines and various web sites. However, there exists no system in the prior art that provides a comprehensive list of recommendations for a user based on his query. Therefore, users utilize specific search engine and specific web site individually to get the recommendations corresponding to a specific query. Such ways of utilizing different search tools for searching information/recommendations corresponding to the user's need may consume user's time and effort in switching from one search tool to another search tool based on the type of the user's need.

Further, searching, performed through such tools, is based just on keywords present in the query that represents the need of the user. Due to this, number of recommendations obtained through such searches is typically large. The user needs to type in additional keywords to narrow the search results and the search tools do not assist the user in choosing the additional keywords. Due to this, the user is burdened with the task of deciding and typing the additional keywords to be inserted in a query in order to obtain relevant recommendations. This results in consuming significant time and effort from the user in eliciting the recommendations that suit his profile, need and preference.

Additionally, if the user gets any relevant recommendation, the user may not get probable options (additional information) corresponding to the recommendation to fulfill the need of the user. For example, if the user gets a relevant recommendation that provides the name of a particular restaurant corresponding to the need of the user, the user may require obtaining additional information corresponding to that particular restaurant to fulfill his/her need. Additional information, in this example, may include menu, table booking system, restaurant timings and the like. Further, conventionally the user is required to search additional information corresponding to the relevant recommendation. Such activities to get sufficient information corresponding to the suggested recommendations are time and effort consuming. Further, conventional ways of providing relevant recommendations do not provide ways to guide the user to fulfill the need by utilizing the recommendation, such as booking a table in a restaurant, ordering meal from the restaurant for home delivery and the like.

Thus, conventional methods are lacking in providing general purpose service to provide the user with useful, personalized and relevant recommendations that the user can then act upon to resolve his/her need for a particular situation of the user. The conventional methods return the same results for the same query submitted from the same location and it does not differ based on the user's preferences and context under which the user is requesting the information.

Specialized ticketing solutions permit more detailed information, and fulfillment, but provide limited alternatives. General search tools provide wide range of searches, but do not provide enough options for user to define his/her need. Further the search tools provide limited additional information on availability and fulfillment

In the light of the foregoing discussion, there is a need for an efficient method and system for providing one or more activity recommendations relevant to needs of the user.

Further, it is desirable for the system and method to aid the user in fulfilling and socializing while performing a selected activity. In this respect, the systems and methods of providing recommendations to a user according to the present invention substantially departs from the conventional concepts and designs of the prior art, and in doing so provides an apparatus primarily developed for the purpose of providing one or more activity recommendations relevant to fulfill a need of the user.

### SUMMARY OF THE INVENTION

The above-mentioned shortcomings, disadvantages and problems are addressed herein which will be understood by reading and understanding the following specification. In view of the foregoing disadvantages inherent in the known types of searching and recommendation systems and methods now present in the prior art, the present invention provides an improved system and method for generating activity recommendations, and overcomes the above-mentioned disadvantages and drawbacks of the prior art. As such, the general purpose of the present invention, which will be described subsequently in greater detail, is to provide a new and improved system and method for generating activity recommendations and method which has all the advantages of the prior art mentioned heretofore and many novel features that result in a system and method for generating activity recommendations which is not anticipated, rendered obvious, suggested, or even implied by the prior art, either alone or in any combination thereof.

In one embodiment, an activity recommendation system is provided that comprises a user interface unit for receiving selection for a first set of user inputs, a recommendation engine coupled to the user interface, the recommendation engine configured for processing the selection of user inputs so as to provide at least one activity recommendation to the user based on the user inputs and an activity database module operably coupled to the recommendation engine, the activity database module configured for dynamically maintaining a list of activities so as to fetch and provide the activity recommendation to the user.

In another embodiment, a method of generating one or more activity recommendations for a user is provided. The method comprises steps of receiving selection for a first set of user inputs, retrieving one or more activities from an activity database module based on the selection of user inputs, scoring the activities based on at least one predetermined parameter and presenting at least one activity recommendation to the user based on the scoring.

The invention may also be embodied in a computer program product for providing one or more activity recommendations to a user. The computer program product may include a non-transitory computer usable medium having a set program instructions comprising a program code for providing one or more activity recommendations relevant to the need of the user. The set of instructions may include various commands that instruct a processor to perform specific tasks such as receiving selection for a first set of user inputs, retrieving one or more activities from an activity database module based on the selection of user inputs, scoring the activities based on at least one predetermined parameter and presenting at least one activity recommendation to the user based on the scoring.

Systems and methods of varying scope are described herein. In addition to the aspects and advantages described in this summary, further aspects and advantages will become apparent by reference to the drawings and with reference to the detailed description that follows.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved system and method for generating activity recommendations that has all of the advantages of the prior art searching and recommendations systems and/or methods and none of the disadvantages.

It is another object of the present invention to provide a new and improved system and method for generating activity recommendations that may be easily and efficiently manufactured and marketed.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows a schematic diagram of an activity recommendation system as described in an embodiment;

FIG. 2 shows a block diagram of the activity recommendation system shown in

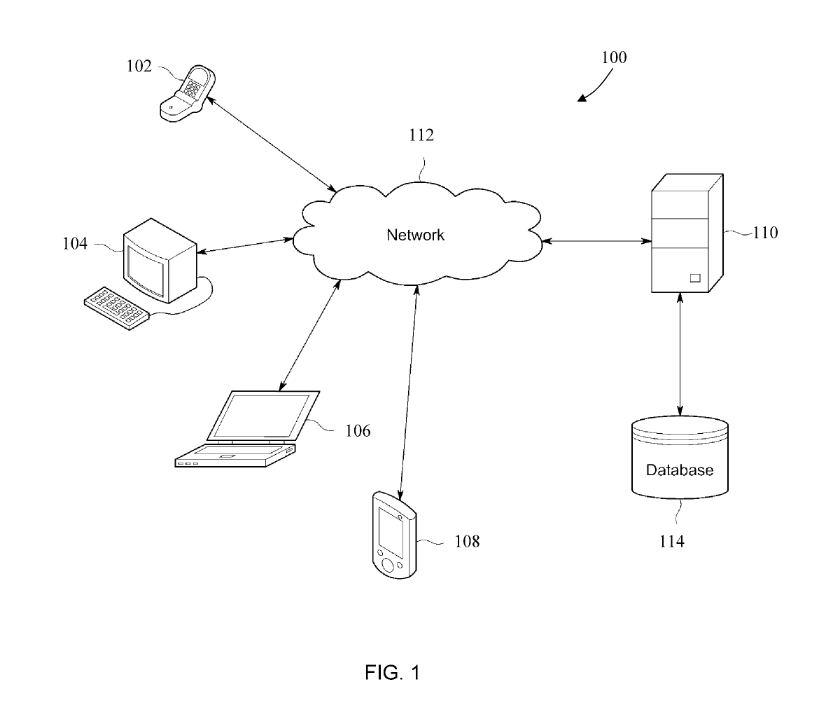

FIG. 1;

FIG. 3 shows a flow diagram depicting a method of generating one or more activity recommendations as described in an embodiment;

FIG. 4 shows a flow diagram depicting a method of performing at least one of the one or more activity recommendations as described in an embodiment; and

FIG. 5 shows a flow diagram depicting a method of dynamically maintaining list of activities as described in an embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

To address shortcomings of the prior art, the invention provides a method, a system and a computer program product for providing one or more activity recommendations relevant to a need of a user. An activity recommendation comprises an activity that is recommended to the user based on his/her need.

FIG. 1 is a block diagram of an environment 100 in accordance with various embodiments of the invention. The environment 100 includes one or more personal communication devices 102, 104, 106 and 108 configured for wirelessly communicating with an activity database module 110 disposed on the cloud 112. The personal communication device may comprise one of a smart phone 102, personal computer 104, notebook 106, tablet (not shown), personal digital assistant 108, connected television (not shown) and any such device capable of having access to the Internet 112.

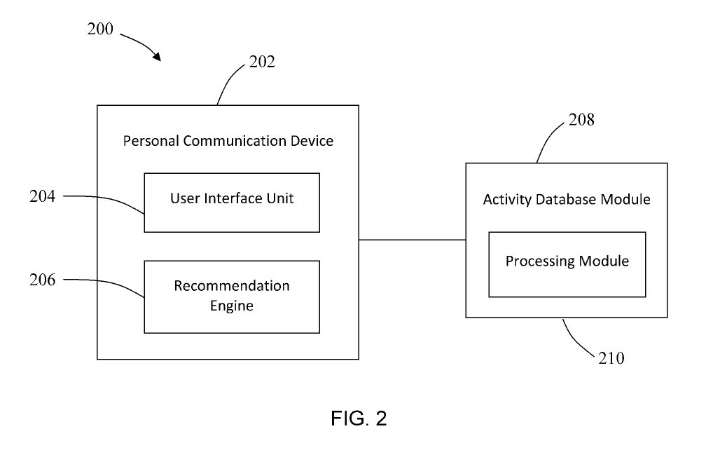

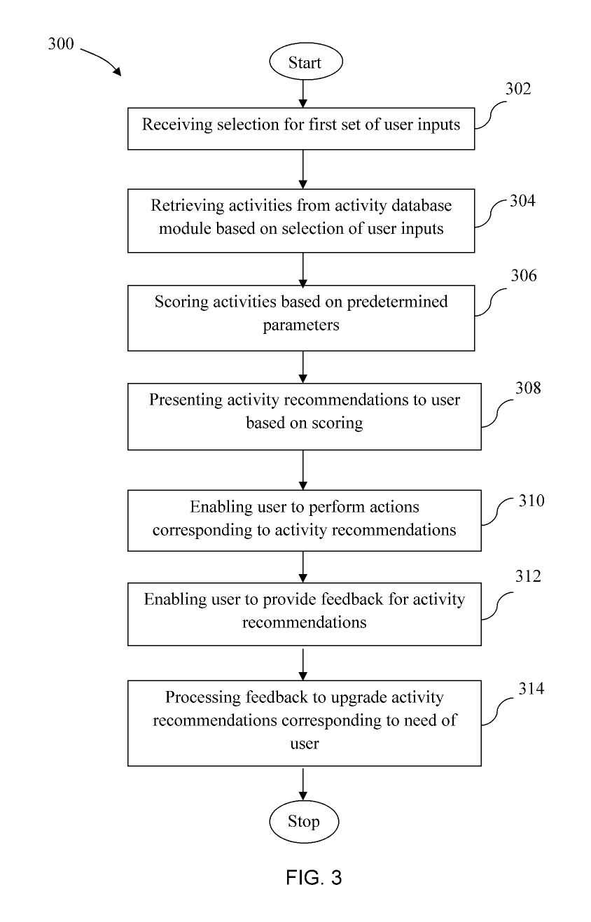

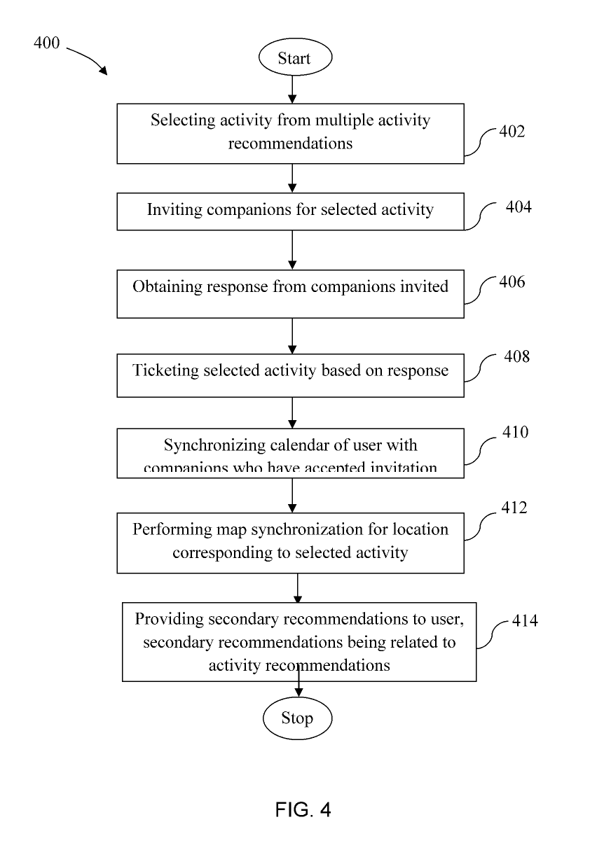

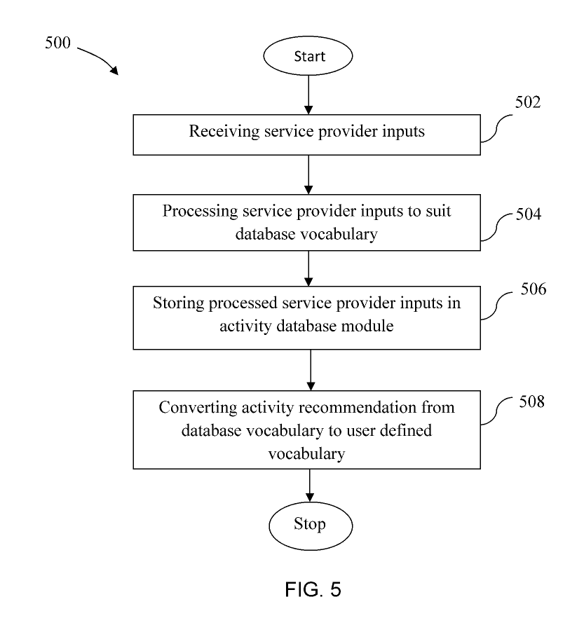

In one embodiment, as shown in FIG. 2, an activity recommendation system 200 is provided that comprises a user interface unit 204 for receiving selection for a first set of user inputs, a recommendation engine 206 coupled to the user interface unit, the recommendation engine configured for processing the selection of user inputs so as to provide at least one activity recommendation to a user based on the user inputs and an activity database module 208 operably coupled to the recommendation engine, the activity database module configured for dynamically maintaining a list of activities so as to fetch and provide the activity recommendation to the user.

The activity recommendation system can be installed in a personal communication device 202, uploaded on a server, and alternatively can be installed as an application on a social networking site. Moreover, the activity recommendation system can also be a standalone module that can be used to provide the one or more activity recommendations responsive to the need of a user. Examples of types of the need include, but are not limited to, a personal need, an informational need, an entertainment need and a social need.

The user inputs may be provided to the activity recommendation system 200 through the user interface unit 204. In one embodiment, the activity recommendation system 200 may comprise a graphical user interface (GUI) to enable the user to provide user inputs in the form of a search query. In another embodiment, the user may be enabled to provide a selection for the user inputs thereby avoiding the need for the user to type in the search query. Additionally, the activity recommendation system 200 may provide various features to the user to modify the need.

In one embodiment, the recommendation engine 206 is a processing unit that may be installed in the personal communication device 202 of the user having the user interface unit 204. Further, the activity database module 208 may be installed on Cloud. As an alternative, the activity database module 208 may be installed in another electronic device comprising a processing unit. The personal communication device 202 may be coupled to the electronic device via a network 112. Examples of network may include, but are not limited to, internet, Ethernet, local area network (LAN), wireless, wide area network (WAN), metropolitan area network (MAN), and small area network.

The activity database module 208 comprises an activity database and a processing module 210 coupled to the activity database. The activity database is a universal, scalable and aggregated database, listing publicly available activities. The list of activities that may have been gathered using one or more searching tools. Examples of the searching tools include, but are not limited to, various search engines such as ‘Google’ and ‘Yahoo’ and various web sites such as ‘ask.com’, ‘Shopzilla.com’, ‘altavista.com’, ‘about.com’, ‘answers.yahoo.com’, ‘Wikipedia.org’, ‘yelp.com’, Sabre, ITA Software, Last.fm, Amazon, etc. Furthermore, the searching tools may include various websites such as, but are not limited to, social networking web sites, for example, Orkut, Facebook, Google plus and twitter, public networking web sites, domain specific sites and private web sites.

The data required for preparing the list of activities in the activity database may also be obtained from Application Program Interface (API) links or batch uploads from one or more service providers who may include partners, specialized players, listing companies and additional services companies that serve sub-sections of the market.

The user inputs the query by selecting one or more user inputs presented to him by the user interface unit 204. The presentation of use inputs to the user for selection is efficient and demands reduced time from the user for entering user inputs. Further, presentation of the user inputs for selection mitigates the risk of missing out on the most appropriate choice. Though the user interface unit 204 described herein is configured for providing selection options for user inputs, skilled artisans shall however appreciate that the query may be presented in various forms such as textual format, a video format, an audio format, an image and the like.

In one embodiment, the invention provides a layered structure for providing inputs. In the layered structure, a query is structured in multiple layers, each layer comprising a set of user inputs. Accordingly, a first set of user inputs include at least one of need, location, duration and company.

The recommendation engine 206 is configured for providing at least one additional set of user inputs for selection by the user, the additional set of user inputs being derived from the first set of user inputs. The additional set of user inputs help the user in narrowing his search request, as the additional set of user inputs are aligned with the first set of user inputs. Each of user inputs may be presented to the user in an objective form for enabling him to select one of the user inputs. Alternatively, each set of the user inputs may be entered by the user.

Accordingly, in one exemplary embodiment, the user provides the first set of user inputs that comprise context, time, location and companion. For example, an input string such as “Relax, Saturday, Times Square, John” may be interpreted by the recommendation engine 206 as the user is in the mood to relax with companion John on Saturday at or around Times Square, New York. Upon receiving this query, the recommendation engine 206 may provide additional set of user inputs for selection by the user that comprise 3 PM, 4 PM, 5 PM and the like. The user may narrow the search by selecting one of the options presented (for example 3 PM). For this input, the recommendation engine 206 may come up with a list of activities that can be performed at or around Times Square around 3 PM on Saturday, which would tend to provide a relaxing experience for the user and John.

Embedded in the GUI are inputs for the user to view and/or add and/or modify and/or delete one or more filters that are one basis for creating the recommendations. Enabling the user to view and/or add and/or modify and/or delete the filters facilitate the user in tailoring his query to suit his needs. For example, the user who is not interested in very strenuous activity may disable that aspect, while choosing options within “Games”.

The user interface unit 204 upon receiving the user inputs transmits the query to the recommendation engine 206. The recommendation engine 206 is configured for searching the activity database module 208 for recommendations, aggregating the search results and scoring the search results based on one or more predetermined parameters.

In one embodiment, some of the searching tools are configured to allow one or more users to express their opinions on a particular recommendation associated with the need. The opinions thus expressed may be used for scoring the activities. Further, the scoring is performed by using one or more predetermined parameters that comprise rating provided by users of social media, ‘Static and Dynamic profile’ of the user, event or situation context corresponding to the user, ‘previous needs and transactions’, past behavior and information from public and social networks. The static and dynamic profile information may include, the user's personal and family profile, user's preferences (either specified by the user or derived from previous interaction of the user with the activity recommendation system 200), current location of the user, recent activities of the user, past behavior of the user and the like. The past behavior of the user can be determined by maintaining a history of one or more queries and their corresponding one or more recommendations.

In one embodiment, the predetermined parameters for scoring may include companion's family profile, companion's preferences (either explicitly given by the companion or learnt from previous interaction of the companion with the activity recommendation system 200), current location of the companion, recent activities of the companion, past behavior of the companion and the like.

The scoring may provide ranks to the plurality of recommendations present in the aggregated list of recommendations. In an embodiment, higher ranked recommendations may be selected, from the aggregated list, to form a relevant and limited list of the activity recommendations. In one embodiment, prior to scoring the activity recommendation, the recommendation engine 206 can eliminate activities that are found to be invalid.

The limited list of the activity recommendations thus generated is presented to the user through the user interface unit 204. The recommendation engine 206 is further configured for providing one or more options to the user to enable the user to perform one or more actions corresponding to the one or more recommendations.

In one embodiment, the activity database module 208 may provide various types of additional information that may guide the user to perform one or more actions corresponding to at least one of the recommendations suggested by the recommendation engine 206. Accordingly, additional information corresponding to at least one of the recommended activities may be provided to the user along with the recommendation. For example, if a recommendation includes a restaurant, the relevant information may include menu, timing, cuisine, type, picture, address, map, phone, coupon, booking ability, reviews and the like.

The additional information thus presented enables the user to select one or more of the activities presented in the activity recommendations. The selected activities are subsequently socialized, fulfilled and managed.

Whenever a user adds companions for a selected activity, the recommendation engine 206 also takes into account the history of activities chosen by the companions and each of the companion's profile for refining the activity recommendations presented to the user, thereby increasing the accuracy of selection of relevant activities. The details of each of the companion can be directly input from the user's current databases of contacts, social groups or can be created through the user interface unit 204. Further, the recommendation engine 206 may send invitations inviting one or more companions for the selected activity. The invitation may be communicated to each of the companions through a personal communication device of the companion and/or social platforms where the companion is active. Such communication helps the user in obtaining responses in a time efficient manner.

Upon obtaining a response from the one or more companions invited for the selected activity, the recommendation engine 206 may proceed with ticketing the selected activity based on the response. In one example, if the selected activity is associated with restaurants, ticketing may include at least one of “book a table”, “display menu”, “book a cab to reach the restaurant” and the like.

The recommendation engine 206 is further configured for synchronizing calendar of the user with one or more companions who have accepted the invitation and for performing map synchronization for at least one location corresponding to the selected activity.

In one embodiment, the recommendation engine 206 is adaptive to the users past choices and may tune itself to cater to the needs of the user. For example, the user with John as a companion has chosen to go to the movies, for four previous occasions. Thus “watching a movie” may top the list of activities displayed to the user by the recommendation engine 206 for experiences with John.

In one embodiment, the recommendation engine 206 is configured for presenting the user with a single activity, or a combination of activities to create an experience. In the example above, the recommendation engine 206 would provide combination of choices, for example “Browse Toys and Grab a coffee”, or “Shop at Saks and Get your nails done”. The user can choose to select an entire package or a single activity in the package.

The recommendation engine 206 is further configured for providing at least one secondary recommendation to the user, the secondary recommendation being derived from the activity recommendation. For example for if the user selects the activity “watching a movie” for example, secondary recommendations provided may include hiring a car, or finding a babysitter and the like.

In one embodiment, the processing module 210 of the activity database module 208 is configured for receiving at least one service provider inputs, processing the service provider inputs to suit a database vocabulary and storing the processed service provider inputs in the activity database. The service provider input is provided by one of a user and a service provider. For the purpose of presenting activity recommendations to the user in a user defined vocabulary, the recommendation engine 206 comprises a translation engine (not shown). The translation engine (not shown) is configured for converting the format an activity recommendation from the database vocabulary to the user defined vocabulary, prior to presenting the recommendations to the user.

The disclosed invention provides one or more activity recommendations responsive to the need of the user. The one or more activity recommendations are provided based on user inputs, relevance and preferences of the user. For this purpose, the invention maintains a dynamic and comprehensive listing of various activities derived from multiple online and offline sources. Activity recommendations provided using such an exhaustive database have increased probability to be relevant to the user thereby reducing significant amount of user's time spent on searching disparate sources for relevant recommendations. Furthermore, the user may be enabled to perform at least one activity listed in the activity recommendations suggested in response to the query by the user.

FIG. 3 is a flowchart illustrating a method 300 of providing one or more activity recommendations relevant to a need of a user, in accordance with one embodiment of the invention. The order and number of steps in which the method 300 is described is not intended to be construed as a limitation.

The method 300 comprises steps of receiving selection for a first set of user inputs at step 302, retrieving one or more activities from an activity database module 208 based on the selection of user inputs at step 304, scoring the activities based on at least one predetermined parameter at step 306 and presenting at least one activity recommendation to the user based on the scoring at step 308.

The method 300 further comprises steps of enabling the user to perform at least one activity from the one or more activity recommendations at step 310. This is further explained in conjunction with FIG. 4. With continuing reference to FIG. 3, the method 300 further comprises enabling the user to provide feedback for the one or more activity recommendations at step 312 and processing the feedback to upgrade one or more activity recommendations corresponding to the need of the user at step 314. The feedback may be in the form of an opinion provided by the user for the one or more activity recommendations. In one example “like” can be provided as feedback indicating that the user is interested in the recommendation. In another example “dislike” can be provided as feedback indicating that the user is not interested in the activity recommendation displayed. The feedback thus provided may be processed to upgrade the one or more activity recommendations corresponding to the future need of the user.

FIG. 4 describes a method 400 of enabling the user to perform at least one activity from the one or more activity recommendations. The method 400 comprises steps of enabling the user to perform one or more actions corresponding to at least one of the one or more activity recommendations at step 402. The actions performed by the user may include selecting at least one activity from the one or more activity recommendations being presented. Accordingly, the method 400 further comprises obtaining selection for at least one activity from the one or more activity recommendations presented to the user at step 404, inviting one or more companions for the selected activity at step 406, obtaining a response from one or more companions invited at step 408, ticketing the selected activity based on the response at step 410, synchronizing calendar of the user with one or more companions who have accepted the invitation at step 412 and performing map synchronization for at least one location corresponding to the selected activity at step 414 and providing at least one secondary recommendations to the user at step 416. Such methods are already explained in conjunction with FIG. 1 and thus are not repeated here for the sake of brevity.

Turning now to FIG. 5, a method 500 of dynamically maintaining a list of activities so as to fetch one or more activities and provide the activity recommendations to the user is illustrated. The method 500 comprises receiving at least one service provider input at step 502, processing the service provider input to suit a database vocabulary at step 504 and storing the processed service provider input in the activity database module 208 at step 506. The method 500 further comprises converting the format of an activity recommendation from the database vocabulary to a user defined vocabulary while presenting the activity recommendation to the user at step 508.

Further, the activity database module 208 may maintain and update the list of activities on a periodic basis. The activity database module 208 may have access to various information providers like searching tools, and the data for maintaining and updating the activity database may be obtained through multiple information providers including the searching tools. The searching tools may include various web sites, like (but are not limited to) online directory services, online catalog services, online stores, online travel or entertainment sites, and web search engines. Examples of search engines include, but not limited to, Google, Bing, Yahoo, Ask.com TripleMe.com, Shopzilla.com, altavista.com and the like. Discovery of any new activities that are currently not listed in the activity database may be added to the database after converting the activity into the format of a database vocabulary.

The methods 300, 400 and 500 described herein provide the user with assistance required in the context of using his/her time in a suitable manner including: finding a suitable option for a context, location, time and social group, enabling the user in implementing a selected activity and socializing while implementing the activity, getting assistance in experiencing the activity and enhancing the experience by suggesting one or more incidental services that are necessary for that experience.

The invention may also be embodied in a computer program product for providing one or more activity recommendations to a user. The computer program product may include a non-transitory computer usable medium having a set program instructions comprising a program code for providing one or more activity recommendations relevant to the need of the user. The set of instructions may include various commands that instruct a processor to perform specific tasks such as receiving selection for a first set of user inputs, retrieving one or more activities from the activity database module 208 based on the selection of user inputs, scoring the activities based on at least one predetermined parameter and presenting at least one activity recommendation to the user based on the scoring.

The set of instructions may be in the form of a software program. Further, the software may be in the form of a collection of separate programs, a program module with a large program or a portion of a program module, as in the invention. The software may also include modular programming in the form of object-oriented programming. The processing of input data by the processing machine may be in response to user commands, results of previous processing or a request made by another processing machine.

In various embodiments of the invention, a system and method for generating activity recommendations are described. However, the embodiments are not limited and may be implemented in connection with different applications. The application of the invention can be extended to other areas, for example personal recommendations, social recommendations, vacation recommendations, hospitality recommendations and medical tourism recommendations. The design can be carried further and implemented in various forms and specifications.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An activity recommendation system comprising:
at least one personal communication device comprising a user interface unit for receiving selection for a first set of user inputs;
a recommendation engine coupled to the user interface, the recommendation engine configured for processing the selection of user inputs so as to provide one or more activity recommendations to the user based on the user inputs;
at least one electronic device comprising at least one processing unit, and an activity database module operably coupled to the recommendation engine, the activity database module configured for dynamically maintaining a list of activities so as to fetch and provide the activity recommendations to the user; and
wherein the electronic device is in communication with a cloud network.

2. The activity recommendation system of claim 1, wherein the first set of user inputs include at least one of need, location, duration and company.

3. The activity recommendation system of claim 1, wherein the recommendation engine is configured for providing at least one additional set of user inputs for selection by the user, the additional set of user inputs being derived from the first set of user inputs.

4. The activity recommendation system of claim 1, wherein the activity database module comprises a processing module, the processing module configured for receiving at least one service provider input, processing the service provider input to suit a database vocabulary and storing the processed service provider input in the activity database module.

5. The activity recommendation system of claim 4, wherein the recommendation engine comprises a translation module, the translation module configured for converting the format of an activity recommendation from the database vocabulary to a user defined vocabulary.

6. The activity recommendation system of claim 1, wherein the recommendation engine is configured for providing at least one secondary recommendation to the user, the secondary recommendation being derived from the one or more activity recommendations.

7. A method of generating one or more activity recommendations for a user, said method comprising the steps of:
inputting at least one first set of user inputs on at least one personal communication device;
receiving selection for the first set of user inputs from the personal communication device;
retrieving one or more activities from an activity database module based on the selection of the user inputs, the activity database module being disposed on one of a network, and an electronic device comprising a processing unit;
scoring the activities based on at least one predetermined parameter;
sending at least one activity recommendation to the personal communication device; and
presenting the activity recommendation to the user based on the scoring.

8. The method of claim 7 further comprising the step of enabling the user to perform at least one activity from the activity recommendation.

9. The method of claim 8, comprising at least one of:
enabling the user to select an activity from the activity recommendation;
obtaining a selection for the activity;
inviting one or more companions for the selected activity;
obtaining a response from one or more invited companions;
ticketing the selected activity based on a response from one or more invited companions;
synchronizing calendar of the user with one or more companions who have accepted an invitation; and
performing map synchronization for at least one location corresponding to a selected activity.

10. The method of claim 8 further comprising the steps of:
enabling the user to provide feedback for the activity recommendation; and
processing the feedback to upgrade the activity recommendation corresponding to a need of the user.

11. The method of claim 7 further comprising the step of maintaining a list of activities, dynamically, so as to fetch and provide the activity recommendation to the user.

12. The method of claim 7, wherein the predetermined parameter comprises history of the user activities, user profile, and rating provided by users of social media.

13. The method of claim 7, wherein the first set of user inputs include at least one of need, location, duration and company.

14. The method of claim 7 further comprising the step of providing at least one additional set of user inputs for selection by the user, the additional set of user inputs being derived from the first set of user inputs.

15. The method of claim 11, wherein dynamically maintaining the activities comprises the steps of:
receiving at least one service provider input;
processing the service provider input to suit a database vocabulary; and
storing the processed service provider input in the activity database module.

16. The method of claim 15, wherein presenting the activity recommendation comprises converting the format of at least one of the activity recommendation from that of the database vocabulary to a user defined vocabulary.

17. The method of claim 7 further comprising the step of providing at least one secondary recommendation to the user, the secondary recommendations being related to the activity recommendation.

18. A computer program product stored on a non-transitory computer readable media, the computer program product comprising instructions for execution by a processor, such that the instructions when executed generate one or more activity recommendations to a user and wherein the instructions comprising:
computer usable program code for receiving selection for a first set of user inputs; and
computer usable program code for processing the user inputs so as to provide the activity recommendations to the user based on the user inputs, and wherein the code for processing comprises:
computer usable program code for retrieving one or more activities from an activity database module based on the user inputs;
computer usable program code for scoring the activities based on at least one predetermined parameter;
computer usable program code for presenting the activity recommendations to the user based on the scoring; and
computer usable program code for dynamically maintaining a list of activities so as to fetch and provide the activity recommendations to the user.

19. The computer program product of claim 18 further comprising computer usable program code for providing at least one additional set of user inputs for selection by the user, the additional set of user inputs being derived from the first set of user inputs, and wherein the code for dynamically maintaining the activities comprises:
computer usable program code for receiving at least one service provider input;
computer usable program code for processing the service provider input to suit a database vocabulary; and
computer usable program code for storing the processed service provider input in the activity database module.

20. The computer program product of claim 19, wherein the code for presenting the activity recommendations comprises code for converting the format of an activity recommendation from that of the database vocabulary to a user defined vocabulary, and wherein the computer program product further comprising computer usable program code for providing at least one secondary recommendation to the user, the secondary recommendations being related to the activity recommendations.
